(19) United States
(12) Patent Application Publication
(10) Pub. No.: US 2026/0008406 A1
(43) Pub. Date: Jan. 8, 2026

(54) RECEIVING COMPONENT FOR A COVER LENS OF A HEADLAMP, ASSEMBLY, HEADLAMP FOR A MOTOR VEHICLE, AND METHOD FOR CHANGING A COVER LENS

(71) Applicant: HELLA GMBH & CO. KGAA, Lippstadt (DE)

(72) Inventor: Paul Friesen, Rheda-Wiedenbrück (DE)

(21) Appl. No.: 19/252,135

(22) Filed: Jun. 27, 2025

(30) Foreign Application Priority Data
Jul. 3, 2024 (DE) 102024118825.1

(51) Int. Cl. B60Q 1/04; B60Q 1/00; F21S 41/20; F21S 41/29; F21S 45/50

(52) U.S. Cl. CPC B60Q 1/0466; B60Q 1/0064; B60Q 1/0433; B60Q 1/0441; F21S 41/2805; F21S 41/29; F21S 45/50

(57) ABSTRACT

The present invention relates to a receiving component for a cover lens of a headlamp of a motor vehicle. The receiving component includes at least a carrier frame and a sealing element, wherein the carrier frame has a first connecting means for establishing an adhesive connection with the cover lens and a second connecting means for establishing a detachable connection with a housing of the headlamp, and wherein the sealing element is designed to seal a gap between the carrier frame and a body part of the motor vehicle.

### CROSS-REFERENCE TO RELATED APPLICATIONS

The present application claims the benefit of German Patent Application No. 10-2024-118-825.1, filed Jul. 3, 2024, the disclosure of which is incorporated by reference.

### FIELD OF THE INVENTION

The present invention relates to a receiving component for a cover lens of a motor vehicle headlamp, to an assembly formed from the receiving component and a cover lens, to a headlamp equipped therewith, and to a method for changing the cover lens of the headlamp.

### BACKGROUND OF THE INVENTION

Motor vehicles headlamps of have cover lenses made of plastic that close the light outlet side of the headlamp housing. The cover lens is typically attached to the housing by means of an adhesive connection, which also ensures that the inside of the housing is sealed. In many cases, the prior art also includes external sealing elements made of a soft plastic arranged in the area around the adhesive connection, which substantially seal the gap between the headlamp and the surrounding bodywork of the associated motor vehicle in an airtight manner in order to reduce the drag coefficient (“Ca”).

In the prior art, replacement of the cover lenses is typically not intended or can only be carried out with great effort. The adhesive connections of the cover lenses are typically formed using non-detachable two-component adhesives, as this is the only way to achieve permanent stability and integrity of the adhesive connection under the operating conditions that occur. When changing the cover lenses, a great deal of effort is required to loosen such adhesive connections and, if necessary, to dismantle and later reattach the external sealing elements.

### SUMMARY OF THE INVENTION

It is the object of the present invention to propose an alternative design for connecting a cover lens to a headlamp, which provides for replacement of the cover lens.

This object is achieved by a receiving component, an assembly, a headlamp, and a method. Advantageous further embodiments of the invention are also set forth herein.

The technical teaching of the invention discloses a receiving component for a cover lens of a headlamp, comprising at least a carrier frame and a sealing element, wherein the carrier frame comprises a first connecting means for establishing an adhesive connection with the cover lens and a second connecting means for establishing a detachable connection with the housing of the headlamp, and wherein the sealing element is designed to seal a gap between the carrier frame and a body part of the associated motor vehicle.

The invention provides a functionally integrated interface component with the receiving component, which, on the one hand, indirectly enables a detachable connection of the connecting washer to the housing and, on the other hand, ensures the aerodynamically advantageous sealing of the gap to the body surrounding the associated headlamp by means of the sealing element. The carrier frame is configured as a rigid and suitably load-bearing component, and the at least one sealing element is made of a comparatively soft, and in particular elastically deformable, plastic.

The receiving component is preferably manufactured by means of two-component injection molding, wherein the carrier frame comprises a fiber-reinforced thermoplastic and/or the sealing element comprises a thermoplastic elastomer. A suitable material for the carrier frame is, for example, fiber-reinforced polypropylene with a glass fiber content in the range of 25-35% by volume. Preferably, the same material can be selected for the carrier frame as for the housing of the headlamp, so that a reliable connection can be formed between these two components, even under thermal stress. The sealing element is made of a thermoplastic polyurethane, for example. Alternatively, the sealing element may comprise a suitably modified polyphenyl ether.

The first connecting means of the carrier frame for establishing the adhesive connection with the cover lens is preferably designed as a circumferential channel, which is provided for receiving an adhesive and a collar of the cover lens projecting into the adhesive. The surfaces of the channel and the collar thus form the joining surfaces of the adhesive connection. In particular, the channel and the associated collar are fully circumferential, so that a complete seal against external media, in particular moisture, is provided during operation. Alternatively, the first connecting means can be designed as a circumferential collar, and an associated channel for receiving an adhesive bed is provided on the cover lens.

The second connecting means of the carrier frame has, for example, at least one snap hook, which is provided to form a detachable snap connection with an associated joining portion of the housing of the headlamp. Alternatively or additionally, the second connecting means can be designed to form a screw connection or a clamp connection with the housing.

In an advantageous embodiment, the carrier frame comprises a sealing portion for forming a seal between the carrier frame and the housing, wherein the sealing portion is designed as a circumferential collar which is provided for projecting into an associated sealing means on the housing. The interior of the housing is sealed against the operating environment by the separate seal. In particular, the seal is also designed to be detachable or removable.

In a further embodiment, the carrier frame comprises a predetermined breaking point, in particular a circumferential notch. The predetermined breaking point serves to protect pedestrians in the event of a collision with the associated headlamp of a motor vehicle, i.e. in the area of the predetermined breaking point, a targeted failure of the carrier frame is provided for the benefit of pedestrian protection. In contrast to cover lenses, which are typically formed from a hard-coated polycarbonate, the fracture behavior of the carrier frame according to the invention can be reliably predicted by means of simulations, so that the introduction of a predetermined breaking point in the carrier frame is particularly effective. In addition or alternatively, the carrier frame may be made of a material with a suitably low ductility, which provokes material failure of the carrier frame in the event of a collision.

The invention also relates to an assembly for a headlamp of a motor vehicle, comprising a receiving component according to any of the aforementioned embodiments and a cover lens, wherein the cover lens is connected to the carrier frame of the receiving component by means of an adhesive connection. The adhesive connection is formed by means of the first connecting means of the carrier frame, which is designed in particular as a fully circumferential and adhesive-filled channel, wherein a matching collar of the cover lens projects into the adhesive bed thus formed. Preferably, the adhesive connection is formed with an insoluble two-component adhesive that ensures the permanent operational strength of the adhesive connection. Such an adhesive connection is also particularly suitable in view of the fact that conventional cover lenses are typically subjected to a protective coating and subsequent heat treatment, which results in significant dimensional distortion. An adhesive connection formed by means of an adhesive bed is capable of compensating for such distortion to a sufficient extent. In contrast, forming a detachable connection, in particular a snap connection, directly between the cover lens and the housing would not be very practical due to the distortion of the cover lens and would result in a lot of production waste. According to the invention, the assembly is therefore formed with the receiving component, which represents the interface for the detachable connection of the cover lens to the housing. With the assembly according to the invention, it is thus possible to replace the cover lens if necessary, for example if the cover lens is damaged or in order to access components of the headlamp housed in the housing for maintenance or replacement.

Furthermore, the invention relates to a headlamp for a motor vehicle, comprising at least an assembly according to the invention and a housing, wherein the housing is connected to the carrier frame of the receiving component by means of a detachable connection. The lighting components of the headlamp are accommodated in the housing, and the housing is closed at the front by the assembly. In the installed position of the headlamp in the motor vehicle, the gap to the surrounding body parts is sealed substantially airtight by the at least one sealing element of the receiving component according to the invention.

For example, the detachable connection between the carrier frame and the housing is designed as a snap connection, a screw connection, or a clamp connection. A clamp connection can be created by stapling metal clamps. To form a seal between the carrier frame and the housing, the housing preferably has a circumferential channel with a sealing means accommodated therein, in particular a sponge rubber element, a sealing foam, or a hot-melt adhesive, wherein the carrier frame has a sealing portion in the form of a circumferential collar which projects into the sealing means.

The invention also relates to a method for changing the cover lens of a headlamp according to the invention, comprising at least the following steps: loosening the detachable connection between the carrier frame of the receiving component of the assembly and the housing; removing the assembly with the cover lens to be replaced; arranging a new assembly on the housing; and forming a detachable connection between the carrier frame of the receiving component of the new assembly and the housing.

Depending on the specific design of the detachable connection, it is released, for example, by spreading open a snap connection, unscrewing a screw connection, or heating an adhesive connection formed with a removable hot melt adhesive. When replacing the cover lens, the seal between the carrier frame and the housing may also be replaced.

### BRIEF DESCRIPTION OF THE DRAWING

FIG. 1 shows a schematic side view of a part of a headlamp according to the invention in the installed position on a motor vehicle.

### DETAILED DESCRIPTION OF THE CURRENT EMBODIMENT

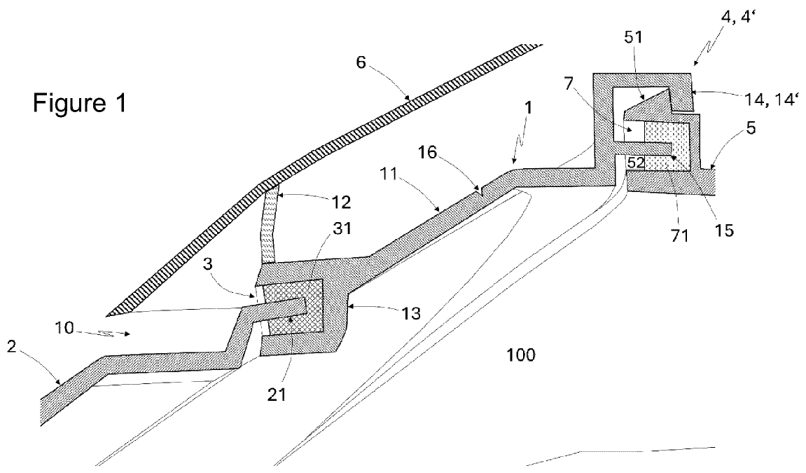

The invention is illustrated in more detail below by means of the description of a preferred exemplary embodiment and FIG. 1.

FIG. 1 shows a schematic sectional view of a part of a headlamp 100 according to the invention in the installed position on a motor vehicle. The headlamp 100 comprises the assembly 10 consisting of the receiving component 1 and the cover lens 2, as well as the housing 5. The carrier frame 11 of the receiving component 1 acts as an interface between the cover lens 2 and the housing 5, wherein the cover lens 2 is connected to the carrier frame 11 by means of the adhesive connection 3 and the housing 5 is connected by means of the detachable connection 4 designed as a snap connection 4′. Furthermore, the receiving component 1 has the sealing element 12, which seals the gap between the carrier frame 11 and the body part 6 of the motor vehicle. For complete sealing of the gap, the sealing element 12 extends over all associated portions on the outer side of the carrier frame 11.

For example, the cover lens 2 is made of a coated polycarbonate, the carrier frame 11 and the housing 5 are made of a fiber-reinforced thermoplastic, in particular an identical one, and the sealing element 12 is made of a thermoplastic elastomer or a polyphenyl ether.

The adhesive connection 3 between the carrier frame 11 and the cover lens 2 is established by means of the first connecting means 13, which is designed as a circumferential channel, the adhesive 31 contained therein, and the collar 21 projecting into it. The adhesive 31 is in particular an insoluble two-component type.

The detachable snap connection 4′ between the carrier frame 11 and the housing 5 is formed by means of the second connecting means 14 in the form of a snap hook 14′ and the nose-shaped joining portion 51 on the housing 5. When the snap connection 4′ is assembled, the snap hook 14′ is elastically deformed when it is pushed onto the joining portion 51 until it expands resiliently behind it. To release the snap connection 4′, it is necessary to bend the snap hook 14′ upwards.

The carrier frame 11 also comprises the sealing portion 15 in the form of a circumferential collar, which projects into the sealing means 71 in the channel 52 of the housing 5, so that the seal 7 is formed. This seals the area under the snap connection 4′ so that the inside of the housing 5 is protected against penetrating media. For the purpose of easy replaceability, the sealing means 71 is preferably formed by a sponge rubber element.

For the purpose of pedestrian protection in the event of a collision, the carrier frame 11 comprises a circumferential notch as a predetermined breaking point 16.

By integrating the receiving component 1 according to the invention into the headlamp 100, the cover lens 2 can be easily replaced in the event of damage, for example due to stone chipping. To do this, the entire assembly 10 is removed from the housing 5 by loosening the snap connection 4′ and replaced with a new part of the same design. Furthermore, the detachability of the assembly 10 also allows access to the interior of the housing 5 for maintenance purposes, for example to the light modules housed inside. Once the maintenance work has been completed, the headlamp 100 can be closed again using the same assembly 10.

### LIST OF REFERENCE NUMBERS

100 headlamp
10 assembly
1 receiving component
11 carrier frame
12 sealing element
13 first connecting means
14 second connecting means
14′ snap hook
15 sealing portion
16 predetermined breaking point
2 cover lens
21 collar
3 adhesive connection
31 adhesive
4 detachable connection
4 snap connection
5 housing
51 joining portion
52 channel
6 body part
7 seal
71 sealing means

The above description is that of a current embodiment of the invention. Various alterations and changes can be made without departing from the spirit and broader aspects of the invention. This disclosure is presented for illustrative purposes and should not be interpreted as an exhaustive description of all embodiments of the invention or to limit the scope of the claims to the specific elements illustrated or described in connection with these embodiments. Any reference to elements in the singular, for example, using the articles “a,” “an,” “the,” or “said,” is not to be construed as limiting the element to the singular.

1. A receiving component for a cover lens of a headlamp of a motor vehicle, comprising:
a carrier frame; and
a sealing element;
wherein the carrier frame has a first connecting means for establishing an adhesive connection with the cover lens and a second connecting means for establishing a detachable connection with a housing of the headlamp;
wherein the sealing element is configured to seal a gap between the carrier frame and a body part of the motor vehicle.

2. The receiving component of claim 1, wherein the receiving component is manufactured via two-component injection molding, wherein the carrier frame comprises a fiber-reinforced thermoplastic and the sealing element comprises a thermoplastic elastomer.

3. The receiving component of claim 1, wherein the first connection means is a circumferential channel which receives an adhesive and a collar of the cover lens projecting into the adhesive.

4. The receiving component of claim 1, wherein the detachable connection is a mechanical connection having screws or detents.

5. The receiving component of claim 1, wherein the second connecting means comprises at least one snap hook, which is provided for forming a releasable snap connection with an associated joining portion of the housing.

6. The receiving component of claim 1, wherein the carrier frame comprises a sealing portion for forming a seal between the carrier frame and the housing, wherein the sealing portion is designed as a circumferential collar which is provided for projecting into an associated sealing means on the housing.

7. The receiving component of claim 1, wherein the carrier frame comprises a circumferential notch as a predetermined breaking point.

8. An assembly for a headlamp of a motor vehicle, comprising the receiving component of claim 1 and a cover lens, wherein the cover lens is connected to the carrier frame of the receiving component via an adhesive connection.

9. A headlamp for a motor vehicle, comprising an assembly according to claim 8 and a housing, wherein the housing is connected to the carrier frame of the receiving component via a detachable connection.

10. The headlamp according to claim 9, wherein the detachable connection is configured as a snap connection, a screw connection, or a clamp connection.

11. The headlamp according to claim 9, wherein:
the housing comprises a circumferential channel with a sealing means accommodated therein, the sealing means being a sponge rubber element, a sealing foam, or a hot-melt adhesive;
the carrier frame comprises a sealing portion in the form of a circumferential collar which projects into the sealing means in such a manner that a seal is formed between the carrier frame and the housing.

12. A method for changing a cover lens of the headlamp of claim 9, comprising:
loosening the detachable connection between the carrier frame of the receiving component of the assembly and the housing;
removing the assembly with the cover lens to be replaced;
arranging a new assembly on the housing; and
forming a detachable connection between the carrier frame of the receiving component of the new assembly and the housing.
